(19) United States
(12) Patent Application Publication
(10) Pub. No.: US 2024/0233027 A1
(43) Pub. Date: Jul. 11, 2024

(54) TRANSACTING OF DIGITAL ASSETS / CRYPTOCURRENCY BY COMBINING FUNDAMENTALS ANALYSIS AND TECHNICAL ANALYSIS

(71) Applicant: Bank of America Corporation, Charlotte, NC (US)

(72) Inventors: Vinesh Patel, London (GB); Michael Young, Davidson, NC (US); Timothy Hansford Briggs, London (GB)

(21) Appl. No.: 18/093,852

(22) Filed: Jan. 6, 2023

(51) Int. Cl. G06Q 40/06

(52) U.S. Cl. CPC G06Q 40/06; G06Q 2220/00

(57) ABSTRACT

A computer program product, system, and method for generating a combined score or scores for digital assets or cryptocurrency or stocks, each score based on a combination of fundamentals and technical data, for trading decisions, such as buying, selling, holding, or shorting the asset. The score(s) may relate to long-term, medium-term, and short-term decisions. The scores(s) may be generated using machine learning, artificial intelligence, or behavioral analytics to determine which of the available fundamentals data and technical data to use in the scoring and how much significance and weight to give to each data. The scores(s) may be provided to an automated trading system for generating trades based on the score(s).

### FIELD OF THE DISCLOSURE

Aspects of the disclosure relate to automated transactions for a digital asset or cryptocurrency by combining fundamentals analysis and technical analysis.

### BACKGROUND OF THE DISCLOSURE

A digital asset is an asset stored in a digital form that may have value. A cryptocurrency is a type of digital asset and is a currency that is not reliant on any centralized authority like a government or bank. A cryptocurrency may, for example, use crypto tokens, coins, or other digital currencies.

Investors may strategize as to whether and when to buy, sell, hold, or short assets, such as digital assets, cryptocurrency, or stocks, based on analysis of factors which may be either fundamentals data or technical data. Fundamentals data for a digital asset or cryptocurrency may reflect actual or perceived performance of the digital asset or cryptocurrency. Fundamentals data for a stock may reflect actual or perceived performance of a business, an industry in which the business is situated, or economic conditions associated with the business. Technical data about a digital asset, cryptocurrency, or a stock may be used to attempt to predict a value of the respective digital asset, cryptocurrency or stock of the business based on a historical market data for the respective digital asset, cryptocurrency, or stock.

There is currently no numerical score that may be generated by machine learning and that may be relied on by investors as guidance as to whether to buy, hold, sell, or short an asset that takes into account both fundamentals analysis and technical analysis for the asset, such as a digital asset, cryptocurrency, or stock.

### SUMMARY OF THE DISCLOSURE

It is an object of this invention to provide a way in which to automatically transact a digital asset, cryptocurrency, or a stock by determining scores by combining fundamentals analysis and technical analysis.

A first combined fundamentals analysis and technical analysis scoring computer program product is disclosed. The computer program product may include executable instructions that, when executed by a processor on a computer system, obtain first data for fundamentals analysis of a business by evaluating actual or perceived performance of the business, an industry in which the business is situated, or economic conditions associated with the business, and obtains second data for technical analysis to attempt to predict a value of a stock of the business based on historical market data for the stock. The executable instructions may further generate a score based on a combination of the first data for fundamentals analysis and the second data for technical analysis of the stock. A machine learning algorithm may determine which of the first data for fundamentals analysis and the second data for technical analysis is selected to be used to generate the score. The score may be leveraged to provide guidance for buying, selling, holding, or shorting the stock of the business. The executable instructions may further determine whether to automatically trade the stock for the user, using an automated trading system, based on the score.

The score may represent one of a long-term score, a medium-term score, or a short-term score. In embodiments, long-term may be more than a year in the future, medium-term may be between six to twelve months in the future, and short-term may be less than six months in the future. The score may be a numerical value within a range of values, and subranges within the range of values may signify whether to buy, sell, hold, or short the stock.

One or more additional scores may be generated and may represent one or more of the long-term score, the medium-term score, or the short-term score not represented by the score. The one or more additional scores may be leveraged as additional guidance for determining whether to buy, sell, hold, or short the stock of the business.

The machine learning algorithm may further determine weights to be applied to the selected first data for fundamentals analysis and the second data for technical analysis based on a relevance of each of the selected first data for fundamentals analysis and the second data for technical analysis as a predictor for the type of the score to be generated. The weighting of the first data for fundamentals analysis and the second data for technical analysis to generate the score may be further based on an historical performance of each of the first data and the second data as a predictor for the type of the score to be generated (e.g., the long-term, medium-term, or short-term score).

The executable instructions may further obtain behavioral analytics data of investors that reflects past behavior of the investors, and the generating of the score may be further based on the behavioral analytics data.

The first data for fundamentals analysis of a stock by the computer program product may include, for example, one or more of a report, an article, or a news item about the business, jobs or vacancies at the business, a social media posting, a tweet, a short-term scoring, a long-term scoring, a popularity of a search query, or a research rating for a buy, sell, hold, or overweight about the business, sentiment of analysis of the business in reports, news, or articles, a macroeconomic environment, or interest rates.

The second data for technical analysis of a stock by the computer program product may include, for example, one or more of a moving average (MA) or an exponential moving average (EMA) of changes in the stock price over a predetermined duration, a volume on one or more stock exchanges in a time frame, a length of a period of analysis, historical movements of previous cycles, Bollinger bands, Fibonacci retracement, a relative strength index (RSI), on balance volume (OBV), a stochastic oscillator, on chain metrics, off chain metrics, total assets held on an exchange, an exchange net flow, earnings per share (EPS), a Price to Earnings (P/E) ratio, a Price to Earnings to Growth (P/E/G) ratio, a Price to Book (P/B) ratio, a Dividend Payout Ratio (DPR), a dividend yield, a ratio, or a yield.

A second combined fundamentals analysis and technical analysis scoring computer program product is disclosed. The computer program product may include executable instructions that, when executed by a processor on a computer system, obtain first data for fundamentals analysis that evaluates actual or perceived performance of a digital asset or cryptocurrency, wherein the digital asset or cryptocurrency industry, or economic conditions associated with the digital asset or cryptocurrency, and obtain second data for technical analysis that attempts to predict a future value of the digital asset or cryptocurrency based on historical market data for the digital asset or cryptocurrency. The executable instructions may further generate a score based on a combination of the first data for fundamentals analysis and the second data for technical analysis. A machine learning algorithm may determine which of the first data for fundamentals analysis and the second data for technical analysis is selected to be used to generate the score. The score may be leveraged to provide guidance for buying, selling, holding, or shorting the stock of the digital asset or cryptocurrency. The executable instructions may further determine whether to automatically trade the digital asset or cryptocurrency for the user, using an automated trading system, based on the score.

The score may represent one of a long-term score, a medium-term score, or a short-term score. In embodiments, long-term may be more than a year in the future, medium-term may be between six to twelve months in the future, and short-term may be less than six months in the future. The score may be a numerical value within a range of values, and subranges within the range of values may signify whether to buy, sell, hold, or short the digital asset or cryptocurrency.

One or more additional scores may be generated and may represent one or more of the long-term score, the medium-term score, or the short-term score not represented by the score. The one or more additional scores may be leveraged as additional guidance for determining whether to buy, sell, hold, or short the digital asset or cryptocurrency of the business.

The machine learning algorithm may further determine weights to be applied to the selected first data for fundamentals analysis and the second data for technical analysis based on a relevance of each of the selected first data for fundamentals analysis and the second data for technical analysis as a predictor for the type of the score to be generated. The weighting of the first data for fundamentals analysis and the second data for technical analysis to generate the score may be further based on an historical performance of each of the first data and the second data as a predictor for the type of the score to be generated, i.e., whether to buy, sell, hold, or short in the long-term, medium-term, or short-term.

The executable instructions may further obtain behavioral analytics data of investors that reflects past behavior of the investors, and the generating of the score may be further based on the behavioral analytics data. The behavioral analytics data may include data relating to past user behaviors, and the generating of the score may be customized for the user based on the behavioral analytics data for the user.

The first data for fundamentals analysis of a digital asset or cryptocurrency by the computer program product may, for example, include one or more of a report, an article, or a news item, a social media posting, a tweet, short-term scoring, long-term scoring, sentiment of analysis in reports, news, or articles about the digital asset or cryptocurrency, a macroeconomic environment, interest rates, total assets of the digital asset or cryptocurrency held on an exchange, new developments, a roadmap, releases of software, Github commits, code pushes, wiki edits, comments on commits, repurchase agreements (repos) opened, developer activity, number of active developers, airdrops, a Fear and Greed index, tokenomics (token economics) of the digital asset or cryptocurrency, which may include a monetary policy or a total number of tokens of the digital asset in circulation, or a burning mechanism for the digital asset.

The second data for technical analysis of a digital asset or cryptocurrency by the computer program product may, for example, include one or more of a moving average (MA) or an exponential moving average (EMA) of changes in the price of the digital asset or cryptocurrency over a predetermined duration, a volume on one or more exchanges in a time frame, a length of a period of analysis, historical movements of previous cycles, a research rating from another source for a buy, sell, hold, or overweight, Bollinger bands, Fibonacci retracement, an exchange net flow, a relative strength index (RSI), on balance volume (OBV), a stochastic oscillator, on chain metrics, off chain metrics, earnings per share (EPS), a Price to Earnings (P/E) ratio, a Price to Earnings to Growth (P/E/G) ratio, a Price to Book (P/B) ratio, a Dividend Payout Ratio (DPR), a dividend yield, a ratio, or a yield.

Also disclosed is a non-transitory computer-readable memory storing computer-executable instructions that, when executed by a processor on a computer, cause the computer to obtain first data for fundamentals analysis of a business that evaluate actual or perceived performance of the business, an industry in which the business is situated, or economic conditions associated with the business, and obtain second data for technical analysis to attempt to predict a value of a stock of the business based on historical market data for the stock, generate a score based on a combination of the first data for fundamentals analysis and the second data for technical analysis of the stock. A machine learning algorithm may determine which of the first data for fundamentals analysis and the second data for technical analysis is selected to be used to generate the score and may determine weights to be applied to each of the selected first data for fundamentals analysis and the second data for technical analysis to generate the score. The score may be leveraged to provide guidance for buying, selling, holding, or shorting the stock of the business. In embodiments, an automated trade of the stock, using an automated trading system, may be triggered based on the score.

Also disclosed is a non-transitory computer-readable memory storing computer-executable instructions that, when executed by a processor on a computer, cause the computer to obtain first data for fundamentals analysis that evaluates actual or perceived performance of a digital asset or cryptocurrency, the digital asset or cryptocurrency industry, or economic conditions associated with the digital asset or cryptocurrency, and obtain second data for technical analysis that attempts to predict a future value of the digital asset or cryptocurrency based on historical market data for the digital asset or cryptocurrency. A score may be generated based on a combination of the first data for fundamentals analysis and the second data for technical analysis. A machine learning algorithm may determine which of the first data for fundamentals analysis and the second data for technical analysis is selected to be used to generate the score and may determine weights to be applied to the selected first data for fundamentals analysis and the second data for technical analysis to generate the score. The score may be leveraged to provide guidance for buying, selling, holding, or shorting the digital asset or cryptocurrency. In embodiments, an automated trade of the digital asset or cryptocurrency, using an automated trading system, may be triggered based on the score.

### BRIEF DESCRIPTION OF THE DRAWINGS

The objects and advantages of the disclosure will be apparent upon consideration of the following detailed description, taken in conjunction with the accompanying drawings, in which like reference characters refer to like parts throughout, and in which:

FIG. 1 shows an illustrative system architecture in accordance with principles of the disclosure.

FIG. 2 shows an illustrative apparatus of a device in accordance with principles of the disclosure.

FIG. 3 shows an illustrative system for performing automated scoring in accordance with principles of the disclosure.

FIG. 4 shows another illustrative example of a system for performing automated scoring for stocks in accordance with principles of the disclosure.

FIG. 5 shows an illustrative flow chart of steps that may be performed by an automated scoring system for stocks in accordance with principles of the invention.

FIG. 6(a) shows illustrative examples of data for fundamentals analysis for stocks and how this may affect the scoring for stocks in accordance with principles of the invention.

FIG. 6(b) shows illustrative examples of data for technical analysis for stocks and how this may affect the scoring for stocks in accordance with principles of the invention.

FIG. 7 shows an illustrative example of a system for performing automated scoring for digital assets or cryptocurrency in accordance with principles of the disclosure.

FIG. 8 shows an illustrative flow chart of steps that may be performed by an automated scoring system for digital assets or cryptocurrency in accordance with principles of the invention.

FIG. 9(a) shows illustrative examples of data for fundamentals analysis for digital assets or cryptocurrency and how this may affect the scoring for digital assets or cryptocurrency in accordance with principles of the invention.

FIG. 9(b) shows illustrative examples of data for technical analysis for digital assets or cryptocurrency and how this may affect the scoring for digital assets or cryptocurrency in accordance with principles of the invention.

### DETAILED DESCRIPTION OF THE DISCLOSURE

The present disclosure relates to computer program products, methods, systems, and apparatus that generate one or more scores, each based on a combination of first data for fundamentals analysis and second data for technical analysis of one of digital assets, cryptocurrency, or stocks. A machine learning algorithm may determine which of the first data for fundamentals analysis and the second data for technical analysis is selected to be used to generate the score, how to weight the various technical and fundamentals data and how to increment the score accordingly, where the score provides guidance for buying, selling, holding, or shorting the respective digital asset, cryptocurrency, or stock.

Illustrative embodiments of methods, systems, and apparatus in accordance with the principles of the invention will now be described with reference to the accompanying drawings, which form a part hereof. It is to be understood that other embodiments may be utilized, and structural, functional, and procedural modifications may be made without departing from the scope and spirit of the present invention.

The drawings show illustrative features of methods, systems, and apparatus in accordance with the principles of the invention. The features are illustrated in the context of selected embodiments. It will be understood that features shown in connection with one of the embodiments may be practiced in accordance with the principles of the invention along with features shown in connection with another of the embodiments.

The computer program products, methods, systems, and apparatus described herein are illustrative. The computer program products, methods, systems, and apparatus of the invention may involve some or all of the steps of the illustrative methods and/or some or all of the features of the illustrative system or apparatus. The steps of the methods may be performed in an order other than the order shown or described herein. Some embodiments may omit steps shown or described in connection with the illustrative methods. Some embodiments may include steps that are not shown or described in connection with the illustrative methods, but rather are shown or described in a different portion of the specification.

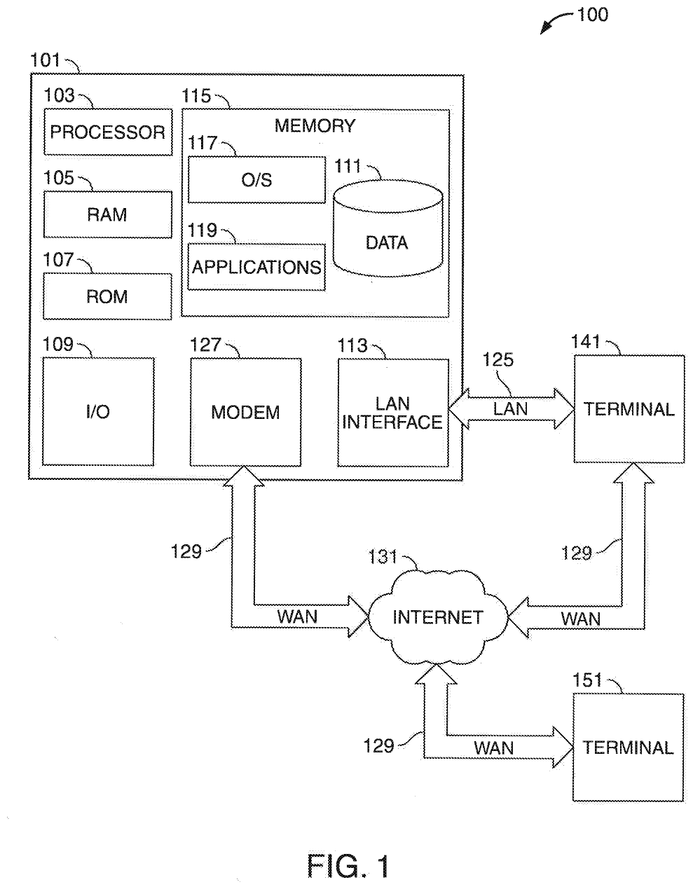

FIG. 1 shows an illustrative block diagram of system 100 that includes computer 101. Computer 101 may alternatively be referred to herein as an “engine,” “server” or a “computing device.” Computer 101 may be any computing device described herein, such as the computing devices running on a computer, smart phones, smart cars, smart cards, and any other mobile device described herein. Elements of system 100, including computer 101, may be used to implement various aspects of the systems and methods disclosed herein.

Computer 101 may have a processor 103 for controlling the operation of the device and its associated components, and may include RAM 105, ROM 107, input/output circuit 109, and a non-transitory or non-volatile memory 115. Machine-readable memory may be configured to store information in machine-readable data structures. Other components commonly used for computers, such as EEPROM or Flash memory or any other suitable components, may also be part of the computer 101.

The memory 115 may be comprised of any suitable permanent storage technology—e.g., a hard drive. The memory 115 may store software including the operating system 117 and application(s) 119 along with any data 111 needed for the operation of computer 101. Memory 115 may also store videos, text, and/or audio assistance files. The data stored in Memory 115 may also be stored in cache memory, or any other suitable memory.

Input/output (“I/O”) module 109 may include connectivity to a microphone, keyboard, touch screen, mouse, and/or stylus through which input may be provided into computer 101. The input may include input relating to cursor movement. The input/output module may also include one or more speakers for providing audio output and a video display device for providing textual, audio, audiovisual, and/or graphical output. The input and output may be related to computer application functionality.

Computer 101 may be connected to other systems via a local area network (LAN) interface 113. Computer 101 may operate in a networked environment supporting connections to one or more remote computers, such as terminals 141 and 151. Terminals 141 and 151 may be personal computers or servers that include many or all of the elements described above relative to computer 101.

In some embodiments, computer 101 and/or Terminals 141 and 151 may be any of mobile devices that may be in electronic communication with consumer device 106 via LAN, WAN or any other suitable short-range communication when a network connection may not be established.

When used in a LAN networking environment, computer 101 is connected to LAN 125 through a LAN interface 113 or an adapter. When used in a WAN networking environment, computer 101 may include a modem 127 or other means for establishing communications over WAN 129, such as Internet 131.

In some embodiments, computer 101 may be connected to one or more other systems via a short-range communication network (not shown). In these embodiments, computer 101 may communicate with one or more other terminals 141 and 151, such as the mobile devices described herein etc., using a personal area network (PAN) such as Bluetooth®, NFC, ZigBee, or any other suitable personal area network.

It will be appreciated that the network connections shown are illustrative and other means of establishing a communications link between computers may be used. The existence of various well-known protocols such as TCP/IP, Ethernet, FTP, HTTP and the like is presumed, and the system can be operated in a client-server configuration to permit retrieval of data from a web-based server or API. Web-based, for the purposes of this application, is to be understood to include a cloud-based system. The web-based server may transmit data to any other suitable computer system. The web-based server may also send computer-readable instructions, together with the data, to any suitable computer system. The computer-readable instructions may be to store the data in cache memory, the hard drive, secondary memory, or any other suitable memory.

Additionally, application program(s) 119, which may be used by computer 101, may include computer executable instructions for invoking functionality related to communication, such as e-mail, Short Message Service (SMS), and voice input and speech recognition applications. Application program(s) 119 (which may be alternatively referred to herein as “plugins,” “applications,” or “apps”) may include computer executable instructions for invoking functionality related to performing various tasks. Application programs 119 may utilize one or more algorithms that process received executable instructions, perform power management routines or other suitable tasks.

Application program(s) 119 may include computer executable instructions (alternatively referred to as “programs”). The computer executable instructions may be embodied in hardware or firmware (not shown). The computer 101 may execute the instructions embodied by the application program(s) 119 to perform various functions.

Application program(s) 119 may utilize the computer-executable instructions executed by a processor. Generally, programs include routines, programs, objects, components, data structures, etc. that perform particular tasks or implement particular abstract data types. A computing system may be operational with distributed computing environments where tasks are performed by remote processing devices that are linked through a communications network. In a distributed computing environment, a program may be located in both local and remote computer storage media including memory storage devices. Computing systems may rely on a network of remote servers hosted on the Internet to store, manage, and process data (e.g., “cloud computing” and/or “fog computing”).

One or more of applications 119 may include one or more algorithms that may be used to implement features of the disclosure.

The invention may be described in the context of computer-executable instructions, such as applications 119, being executed by a computer. Generally, programs include routines, programs, objects, components, data structures, etc., that perform particular tasks or implement particular data types. The invention may also be practiced in distributed computing environments where tasks are performed by remote processing devices that are linked through a communications network. In a distributed computing environment, programs may be located in both local and remote computer storage media including memory storage devices. It should be noted that such programs may be considered, for the purposes of this application, as engines with respect to the performance of the particular tasks to which the programs are assigned.

Computer 101 and/or terminals 141 and 151 may also include various other components, such as a battery, speaker, and/or antennas (not shown). Components of computer system 101 may be linked by a system bus, wirelessly or by other suitable interconnections. Components of computer system 101 may be present on one or more circuit boards. In some embodiments, the components may be integrated into a single chip. The chip may be silicon-based.

Terminal 151 and/or terminal 141 may be portable devices such as a laptop, cell phone, Blackberry™, tablet, smartphone, or any other computing system for receiving, storing, transmitting and/or displaying relevant information. Terminal 151 and/or terminal 141 may be one or more user devices. Terminals 151 and 141 may be identical to computer 101 or different. The differences may be related to hardware components and/or software components.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, tablets, and/or smartphones, multiprocessor systems, microprocessor-based systems, cloud-based systems, programmable consumer electronics, network PCs, minicomputers, mainframe computers, distributed computing environments that include any of the above systems or devices, and the like.

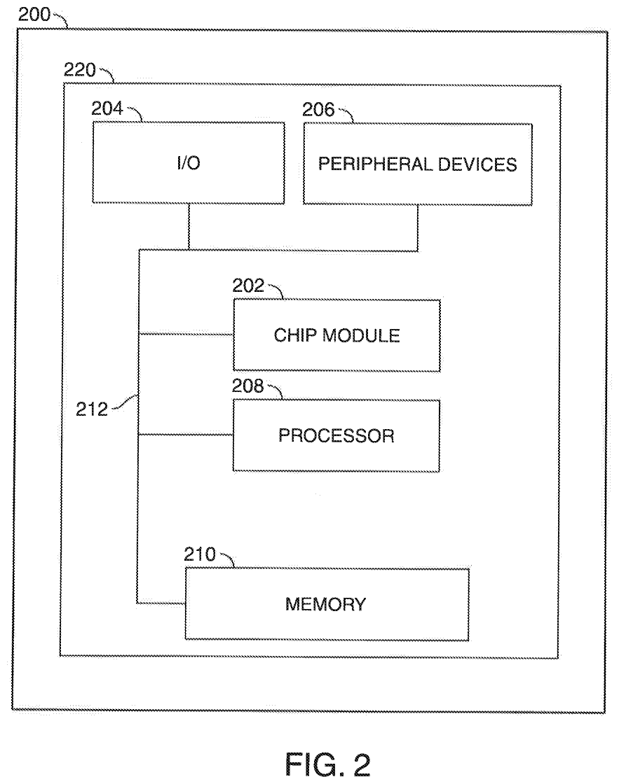

FIG. 2 shows illustrative apparatus 200 that may be configured in accordance with the principles of the disclosure. Apparatus 200 may be a computing device. Apparatus 200 may include chip module 202, which may include one or more integrated circuits, and which may include logic configured to perform any other suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device or any other suitable media or devices; peripheral devices 206, which may include counter timers, real-time timers, power-on reset generators or any other suitable peripheral devices; logical processing device 208, which may compute data structural information and structural parameters of the data; and machine-readable memory 210.

Machine-readable memory 210 may be configured to store in machine-readable data structures: machine executable instructions, (which may be alternatively referred to herein as “computer instructions” or “computer code”), applications such as applications 219, signals, and/or any other suitable information or data structures.

Components 202, 204, 206, 208 and 210 may be coupled together by a system bus or other interconnections 212 and may be present on one or more circuit boards such as circuit board 220. In some embodiments, the components may be integrated into a single chip. The chip may be silicon-based.

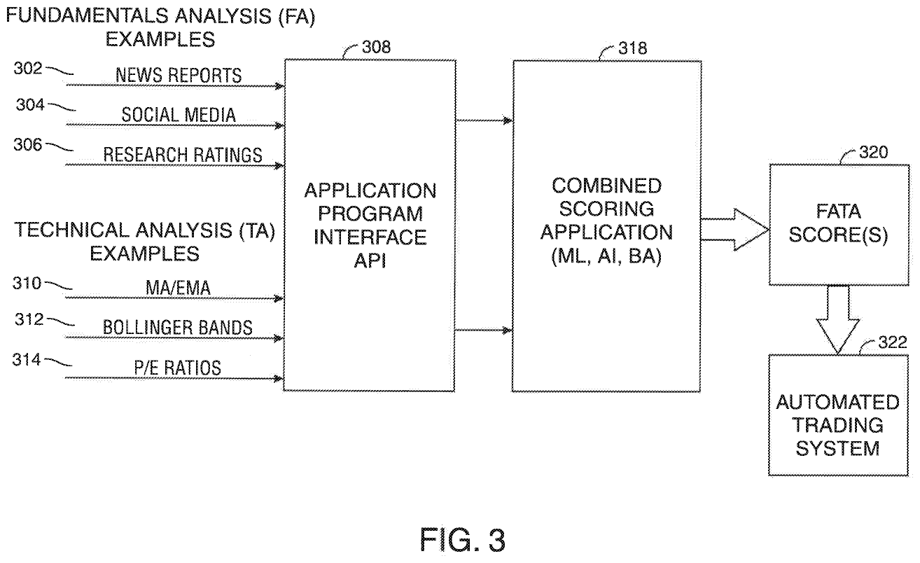

FIG. 3 shows an illustrative combined fundamentals analysis and technical analysis scoring system in accordance with principles of the disclosure that uses a combination of multiple factors used in fundamentals analysis (FA) and technical analysis (TA) to automatically generate one or more combined FATA scores for a stock, a digital asset or cryptocurrency, or other assets.

Data for fundamentals analysis and technical analysis may be obtained by the system via an application program interface (API) 308 for use in performing an automated scoring based on a combination of a fundamentals analysis and a technical analysis. A few non-limiting examples of fundamentals that may be obtained for a fundamentals analysis include news reports 302, such as news reports about a business whose stock is being analyzed, social media content 304, such as references in social media to the business, and research ratings 306. A few non-limiting examples of technical data that may be obtained for a technical analysis include a moving average (MA) or an exponential moving average (EMA) 310 of the business, Bollinger bands 312, and price/earnings (P/E) ratios 314. Additional non-limiting examples of the types of data that may be used for fundamentals analysis and technical analysis are referenced herein. The fundamentals data and the technical data may be obtained from one or multiple sources, some of which may be publicly available and some of which may be available by subscription only.

The data used in the fundamentals analysis and technical analysis may be obtained for input to a combined scoring application 318. Application 318 may use the data in generating one or more scores that each account for both the fundamentals data and technical data.

Scores that are output from the combined scoring application 318 may be termed Fundamental Analysis and Technical Analysis (“FATA”) scores 320. A single score or multiple scores, such as three scores, for example, a long-term score, a medium-term score, and a short-term score, may be generated based on the fundamentals analysis and the technical analysis. After generating the scores for the stock, the combined scoring application 318 may provide the scores to a user to be leveraged by the user as guidance for determining a buy, sell, hold, or short decision. The scores may be provided to an automated trading system 322 that may leverage the scores for performing automated trading, such as buying, selling, or shorting the digital assets, cryptocurrency or stocks based on one or more of the long term, the medium term, or the short term scores. Where multiple scores are generated, a particular one of the scores may be considered most relevant to the investment decision under consideration (e.g., short-term may be more relevant than long-term in a particular instance) and the one or more additional scores may be leveraged as additional guidance for determining whether to buy, sell, hold, or short the asset.

As used herein, long-term, medium-term, and short-term may be different time frames relative to one another. For example, long-term may mean more than a year in the future, medium-term may mean between six to twelve months in the future, and short-term may mean less than six months in the future. Alternatively, the long, medium, and short terms may represent different time frames than in this example.

Scores may be numerical and may have a range. For simplicity, each score of the long-term, medium-term, and short-term scores may span a range of from 0 to 100, or may span different ranges. Each of the scores may have a different range of values. Different subranges within the range of scores may provide guidance to buy, sell, hold, or short the stock. For example, a score between 0 to 25 may provide guidance to sell an asset in the long-term, medium-term, or short-term, a score between 75 to 100 may provide guidance to buy the asset in the long-term, medium-term, or short-term, and a score of between 26 to 74 may suggest a hold. Thus, investment decisions may leverage the scores so that an investment decision may be made based on whether a particular score is within a subrange of values. An automated trading system 322 may, for example, be programmed to buy a certain amount of an asset when one of the scores exceeds a threshold. As another example, a high medium-term score or a high long-term score may trigger a buy decision at a future date taking into account whether the short-term score at the future date is above some level. A low score may indicate a sell and automated trading system 322 may be programmed to sell an amount of the asset. In other embodiments, the scores may be differently calculated such that, for example, a low score suggests a buy and a high score suggests a sell.

The combined scoring application 318 may use a machine learning (ML) and artificial intelligence (AI) algorithm for analyzing the fundamentals and technical data that are input to the combined scoring application 318 and may use behavioral analytics (BA) for analyzing the fundamentals to automatically generate the scores. The ML/AI algorithm may also be used to determine which of the fundamentals data and the technical data that are available are selected for use in generating the scores. The algorithm may base its choice of data based on a past relevance of each of the fundamentals data and the technical data in predicting whether to advise a buy, sell, hold, or short. Some of the fundamentals data and technical data may be more relevant in providing investment guidance. Thus, the machine learning algorithm may further determine a weight to be applied to each data of the selected fundamentals data and the technical data to adjust the scores based on the relevance of each of the selected fundamentals data and the technical data as a predictor for the type of the score to be generated.

The relevance of the fundamentals may also be based on behavioral analytics (BA) that analyze past behaviors or actions of users. The behavioral analytics data may be available to the combined scoring application 318.

A user may provide the initial machine learning algorithm and may modify the algorithm as the user sees appropriate. Alternatively, in embodiments, the combined scoring application 318 may not rely on a machine learning algorithm and may just operate based on a prescribed set of rules that may be modified from time to time.

For a stock, the fundamentals analysis of a business may evaluate the actual or perceived performance of the business, an industry in which the business is situated, or economic conditions associated with the business. The fundamentals analysis may be performed using one or more fundamentals as inputs to the scoring system for a fundamentals analysis of a stock. Some fundamentals that may be relied on in embodiments are shown in FIG. 3.

Non-limiting illustrative examples of inputs for performing a fundamentals analysis of a business for scoring the stock of a business in accordance with principles of the disclosure may include a report, an article, or a news item about the business, the number of jobs or vacancies at the business, a social media posting, a tweet, a short-term scoring, a long-term scoring, a popularity of a search query, a research rating for a buy, sell, hold, or overweight about the business, a sentiment about the business in reports, news, or articles, a macroeconomic environment, an index, such as the Fear and Greed Index, that reflects investor sentiment about the business such as based on market momentum, stock price strength, stock price breadth, put and call options, junk bond demand, market volatility, and safe haven demand, or interest rates. The inputs for fundamentals analysis may include one or more other types of fundamentals data.

For a digital asset or cryptocurrency, the fundamentals analysis of a business may evaluate the actual or perceived performance of the digital asset/cryptocurrency, the digital asset/cryptocurrency industry, or economic conditions associated with the digital asset/cryptocurrency. The fundamentals analysis may be performed using one or more fundamentals as inputs to the scoring system for fundamentals analysis of a digital asset/cryptocurrency.

Some non-limiting illustrative examples of inputs for performing a fundamentals analysis of a digital asset/cryptocurrency in accordance with principles of the disclosure may include a report, an article, or a news item about the digital asset or cryptocurrency, the business behind the digital asset/cryptocurrency, jobs or vacancies at the business, a social media posting, a tweet, a short-term scoring, a long-term scoring, a popularity of a search query, or a research rating for a buy, sell, hold, or overweight about the digital asset/cryptocurrency, sentiment regarding the digital asset/cryptocurrency in reports, news, or articles, a macroeconomic environment, interest rates, fundamentals of the digital asset/cryptocurrency, or fundamentals about other digital assets or cryptocurrencies that may affect the digital asset or cryptocurrency of interest.

Other non-limiting illustrative examples of digital asset/cryptocurrency fundamentals that may be used in a fundamentals analysis performed by combined scoring application 318 may include chain metrics (data related to blockchain technology, such as hash rates, quality and performance, volumes, fees, whether a transaction is on-chain or off-chain, etc.), new developments, a visual roadmap of the direction of the cryptocurrency over time, new releases of software, commits (e.g., a Github or Git commit upon saving new data to the repository), comments on commits, Code Pushes (i.e., deploying mobile app updates to user devices), wiki edits (i.e., edits to a Wikipedia page or information about them), open repositories for open source development, developer activity, number of active developers, airdrops (i.e. an unsolicited distribution of cryptocurrency tokens or coins to multiple wallets to encourage adoption of cryptocurrency), an index, such as the Fear and Greed Index, that reflects investor sentiment, tokenomics of the digital asset, a burning mechanism for removing tokens from circulation, search engine trends, and a lower reserves on an exchange. The fundamentals analysis may also include one or more other types of fundamentals data. In embodiments, multiple inputs may be used.

For a stock, digital asset, or cryptocurrency, the technical analysis of a business may attempt to predict a value of a stock of the business based on historical market data for the stock. The technical analysis may be performed using one or more inputs of technical data to the scoring system for technical analysis of a stock.

Some non-limiting illustrative examples of inputs of technical indicators for performing a technical analysis may include a moving average (MA) or an exponential moving average (EMA) of changes in the stock price over a predetermined duration (e.g., 200 days, 50 days, 20 days, or 8 days), a volume on one or more stock exchanges in a time frame, a length of a period of analysis, historical movements of previous cycles, Bollinger bands, Fibonacci retracement, a relative strength index (RSI), on balance volume (OBV), a stochastic oscillator, on chain metrics, off chain metrics, total assets held on an exchange, an exchange net flow, earnings per share (EPS), a Price to Earnings (P/E) ratio, a Price to Earnings to Growth (P/E/G) ratio, a Price to Book (P/B) ratio, a Dividend Payout Ratio (DPR), a dividend yield, a ratio, or a yield. The inputs for technical analysis may include one or more other types of technical data. In embodiments, multiple inputs may be used. Some of these indicators, such as EPS, the ratios, and yields, may be compared to similar values of these factors for other comparable assets to gain insight into the significance of the values.

The moving average (MA)—or ‘simple moving average’ (SMA)—is a technical indicator used to identify the direction of a current price trend, without the interference of shorter-term price spikes. The MA indicator combines price points of a financial instrument over a specified time frame and divides it by the number of data points to present a single trend line. The data used depends on the length of the MA. For example, a 200-day MA may require 200 days of data.

Exponential moving average (EMA) is another form of moving average that may be used as a technical indicator. The EMA may be taken over a different predetermined durations. For example, the EMA may be measured over 200 days, 50 days, 26 days, or 12 days. Unlike the SMA, it places a greater weight on recent data points, making data more responsive to new information. When used with other indicators, EMAs can help traders confirm significant market moves and gauge their legitimacy. The most popular exponential moving averages are 12- and 26-day EMAs for short term averages, whereas 50- and 200-day EMAs are used as long-term trend indicators.

A stochastic oscillator is a technical indicator that compares a specific closing price of an asset to a range of its prices over time—showing momentum and trend strength. It uses a scale of 0 to 100. A reading below 20 generally represents an oversold market and a reading above 80 an overbought market. However, if a strong trend is present, a correction or rally will not necessarily ensue.

A Bollinger band is an indicator that may be used for a technical analysis that provides a range, with upper and lower price levels, within which the price of an asset typically trades. The width of the band increases and decreases to reflect recent volatility. The narrower the Bollinger band, the lower the perceived volatility of the financial instrument. The wider the bands, the higher the perceived volatility. Bollinger bands may be used to recognize when an asset is trading outside of its usual levels, and to predict long-term price movements. When a price continually moves outside the upper parameters of the band, it could be overbought, and when it moves below the lower band, it could be oversold. Bollinger Bands are price envelopes that are plotted at a standard deviation level above and below a simple moving average of the price. Because the distance of the bands is based on standard deviation, the Bollinger bands adjust to volatility swings in the underlying price.

Fibonacci retracement is a technical indicator that can pinpoint the degree to which a market will move against its current trend. A retracement is when the market experiences a temporary dip—also known as a pullback. A Fibonacci retracement helps to identify possible levels of support and resistance, which could indicate an upward or downward trend. This indicator may therefore help identify levels of support and resistance with this indicator and may assist in determining where to apply stops and limits, or when to open and close their buying and positions.

RSI is a technical indicator that may assist traders identify momentum, market conditions and warning signals for dangerous price movements. RSI is expressed as a number between 0 and 100. An asset around the 70 level is often considered overbought, while an asset at or near 30 is often considered oversold. An overbought signal suggests that short-term gains may be reaching a point of maturity and assets may be in for a price correction. In contrast, an oversold signal could mean that short-term declines are reaching maturity and assets may be in for a rally.

On Balance Volume (OBV) is a technical indicator that may measure buying and selling pressure as a cumulative indicator that adds volume on up days and subtracts volume on down days. When the security closes higher than the previous close, the day's volume is considered up-volume. When the security closes lower than the previous close, the day's volume is considered down-volume.

Some of the above examples of data for fundamentals analysis and technical analysis may be more relevant to a long-term score, a medium-term score, or a short-term score. For example, the MA 8 may be more significant to a short-term score while an MA 200 may be more significant to a long-term score. Moreover, different types of fundamentals data and technical data may be appropriate for other types of assets, as noted further below with reference to digital assets.

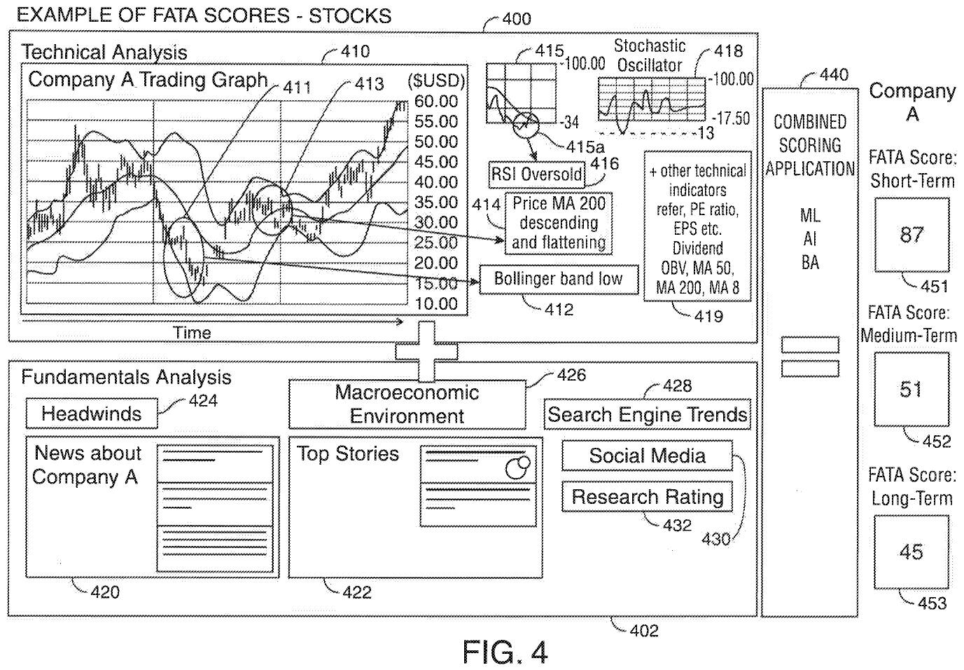

FIG. 4 shows an illustrative example of a system for performing automated scoring for a stock of Company A based on a combination of fundamentals analysis 402 and technical analysis 400. In this example, data that may be obtained, such as via an API, and used for technical analysis include a trading graph 410 that shows the fluctuating historical values of the stock. Graph 410 may be used to determine a variety of relevant inputs to a combined scoring algorithm. For example, a Bollinger band that is circled at 411 may show a low end of the price range for the band, which may indicate an upcoming price rally. As another example, a bear market may be indicated when an MA 200 price falls below a certain level and then descends and flattens. An RSI index may also be available. An RSI at approximately 34 (at 415a) may indicate that a stock is oversold 416. A graph 418 of a stochastic oscillator may confirm that the stock is oversold when the graph 418 shows a level of 13, for example. Other technical indicators 419, such as P/E ratio, earnings per share, dividends, OBV, MA 50, MA 200, MA 8, and others, may also be available in this example.

Data 402 for fundamentals analysis may also be obtained in the system of FIG. 4. Fundamentals data 402 may include news 420 about Company A, news stories, such as general news stories that may affect Company A in some way and so may, in effect, be associated with Company A, information about headwinds 424, i.e., conditions that may adversely impact the company, the industry or the economy, tailwinds that may lead to growth, macroeconomic environment information 426, search engine trends 428, postings on social media 430, and research ratings 432.

The technical data available at 400 and fundamentals data available at 402 may be input to a combined scoring application 440 where ML, AI and BA may be used to generate a score as explained above with respect to FIG. 3.

Combined scoring application 440 may use the obtained fundamentals data and technical data to determine possible FATA scores 451, 452, 453. The determined FATA scores may include, in embodiments, a single score or more than one score, such as the three illustrated scores including a short-term FATA score 451, a medium-term FATA score 452, and a long-term FATA score 453. The scores may then be output from combined scoring application 440, such as to a user or to an automated trading system.

To assist a user to understand the data used in generating the scores, the technical data and fundamentals data, such as the data that are shown at 400 and 402, may be displayed to a user alongside or on the same screen as scores 451, 452, 453 when the scores are determined. These scores may be provided to an automated trading system, e.g., system 322, to conduct a trade based on one or more of the scores. For example, a trade of all or portions of an asset may be automatically performed when one of the FATA scores enters a particular subrange of values or when multiple FATA scores, such as the long-range score and the short-range score, are both within predetermined ranges for their respective scores.

The FATA scores 451, 452, 453 for Company A may be, for example, at a particular time: short-term score=87, medium-term score=51, and long-term score=45. When displayed, scores 451, 452, 453 may be displayed to a user with color coding of the scores or shading areas around the displayed scores. Red shading may, for example, indicate a sell recommendation and blue shading may, for example, indicate a buy recommendation. Various levels of shading may also be used to indicate the strength of a particular recommendation.

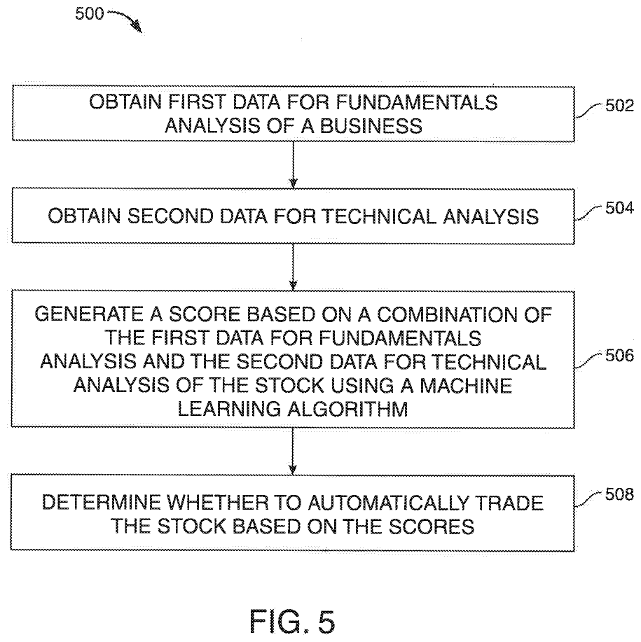

FIG. 5 shows a flow chart 500 that illustrates an example of steps that may be performed by a combined scoring application 318/440 for a stock in accordance with principles of the disclosure. At step 502, first data relating to fundamentals may be obtained for performing a fundamentals analysis of a business. At step 504, second data relating to technical indicators may be obtained for performing a technical analysis. The data that is obtained at steps 502 or 504 may include data inputs that are in condition for an analysis by the combined scoring application or that may be determined before being obtained by combined scoring application. For example, a specific Bollinger band value may be provided to combined scoring application, or a graph of historical stock price data may be provided to the combined scoring application and combined scoring application may determine the value required as an input based on the received graph data.

Next, at step 506, one or more scores may be generated in which each of the scores is based on a combination of the first data for fundamentals analysis and the second data for technical analysis of the stock. Step 506 may include the use of a machine learning algorithm and AI to analyze fundamentals and technical data and behavioral analytics (BA) for analyzing fundamentals (which may analyze users' past actions in similar circumstance) to determine the scores.

At step 508, the score(s) may be output to an automated trading system that may leverage the scores to decide whether to automatically trade the stock based on the scores.

As noted above, fundamentals analysis and technical analysis are both accounted for in generating the FATA scores. In embodiments, the combined scoring application may base a first percentage of the scores upon various fundamentals and may base a second percentage on technical indicators. The percentages may be 50% each, or the percentages may vary with more weight being given to either certain fundamentals or technical indicators.

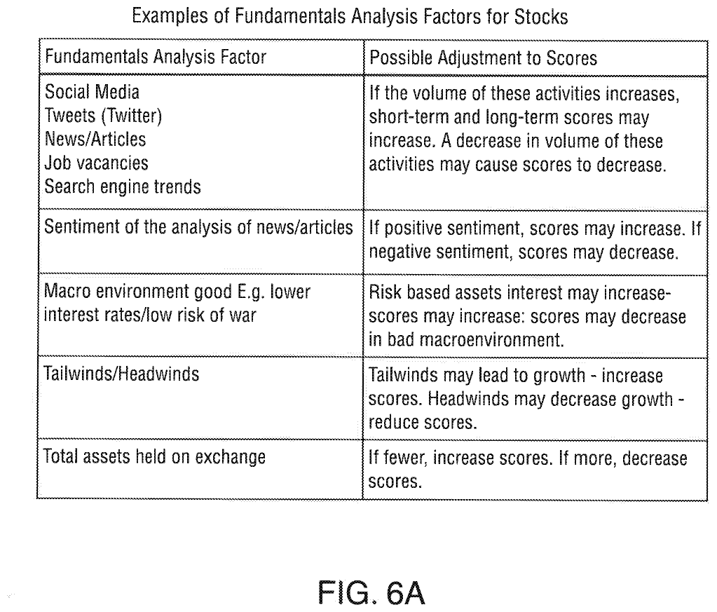

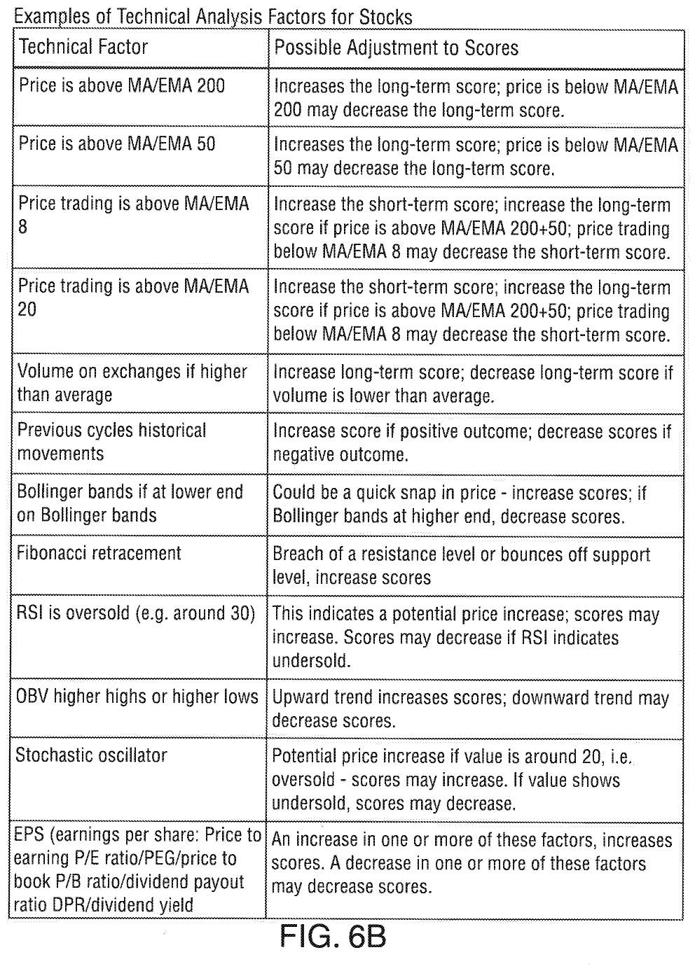

FIG. 6A shows examples of how some of the fundamentals data (fundamentals) mentioned above may impact the scores for stocks, where the highest scores in the range suggest a buy and the lowest scores suggest a sell. For example, where the highest scores suggest a Buy decision, if the volume of related social media activity (e.g., Twitter, Facebook, etc.), news, articles, or job vacancies increase, the short-term and long-term scores may increase. Similarly, scores may increase if the sentiment on the news and in articles is positive, the macroeconomic environment is good, interest rates go lower, the RSI or stochastic oscillator is in a range that indicates an oversold condition, OBV highs or lows go higher, there is a rise in earnings-per-share, or an increased dividend yield. If one or more of the fundamentals show a change in the opposite direction, one or more of the scores may decrease accordingly.

Each of the fundamentals data may be set to cause an incremental increase or decrease in one or more scores on a per-fundamental basis or some of the fundamentals may be analyzed as a group in a determination as to how the fundamentals may increase or decrease the one or more scores. Some fundamentals may be weighted more heavily, such as based on previous effectiveness of those fundamentals.

FIG. 6B shows examples of how some of the technical data mentioned above may impact the scores for stocks. For example, where a stock price is above an MA or EMA 200, or an MA or EMA 80, the long-term score may increase. Where a stock an MA or EMA 8, or an MA or EMA 20, the short-term score may increase, and the long-term score may increase if the price is also above the MA or EMA 200 and MA or EMA 50. As another example, if the volume on the stock exchanges rises higher than average over a certain period “x”, the long-term score may increase. Scores may also increase, for example, where a current cycle resembles previous positive historical movements, if a Bollinger band is at a lower end, or a resistance level of a Fibonacci retracement is breached or there is a bounce off of a support level. If any technical data indicates show a change in the opposite direction, one or more of the scores may decrease. Each technical indicator may be set to cause an incremental increase or decrease in score on a per-indicator basis or some of the technical data may be analyzed as a group in a determination as to how the technical data may impact the score. For example, ranges of the RSI and stochastic oscillator may be considered together as a basis for determining an increase or decrease in scores. Some technical data may be weighted more heavily than other technical data.

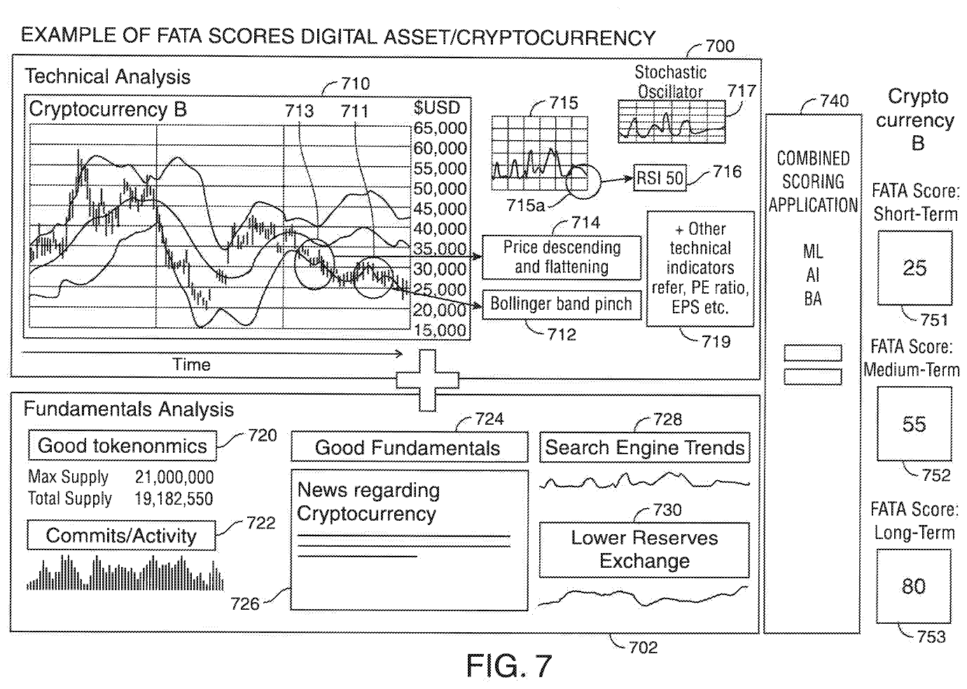

FIG. 7 shows another illustrative example of a system for performing automated scoring system for a digital asset or cryptocurrency based on fundamentals analysis 702 and technical analysis 700.

In this example, technical data that may be obtained, such as via an API, and used for technical analysis include data representable on a graph 710 that show the historical value over time of a particular cryptocurrency B. This data may be used to determine a variety of relevant inputs to a combined scoring algorithm. For example, a Bollinger band 712 that is circled at 711 may show a low end of the price range for the band, which may indicate an upcoming price rally for cryptocurrency B. As another example, a bear market for the cryptocurrency may be signified by an MA 200 price that falls below a certain level and then descends and flattens. An RSI graph 715 may indicate an RSI of approximately 34 (at 715a), which may mean that a cryptocurrency is oversold 716. A graph 718 of a stochastic oscillator may confirm that the stock is oversold when graph 718 shows a level of 13. Other technical indicators 719, such as P/E ratio, earnings per share, dividends, OBV, MA 50, MA 200, MA 8, and others, may also be relied upon.

In the example of FIG. 7, fundamentals data 702 may also be obtained, such as via an API. Data 402 may include, for example, tokenomics 720, commits or activity 722, good fundamentals 724 for cryptocurrency B being reported, news 726 about cryptocurrency, search engine trends 728, and information indicating a lower reserves exchange 730.

The technical data available at 700 and fundamentals data available at 702 may be input to a combined scoring application 740 where ML, AI and BA may be used to generate a score, as explained above with respect to FIG. 3. The fundamentals data and the technical data that may be used by the combined scoring application 740 may be obtained from one or multiple sources, some of which may be publicly available and some of which may be available by subscription only. Additionally, some of the data may be compiled by the entity that operates the combined scoring application 740.

FIG. 7 shows examples of possible FATA scores 751, 752, 753 that may be determined by the combined scoring application 740 that reflects a moment in time in accordance with the obtained fundamentals data and technical data. The determined FATA scores, may then be output from combined scoring application 740, may include, in embodiments, a single score or more than one score, such as the three illustrated scores including a short-term FATA score 751, a medium-term FATA score 752, and a long-term FATA score 753. To assist a user to understand the basis and possibly the source for the scores, the technical data and fundamentals data that is shown at 700 and 702 relied upon may be displayed to a user alongside or on the same screen as scores 751, 752, 753. These scores may be provided to an automated trading system, e.g., system 322, to conduct a trade of the cryptocurrency based on one or more of the scores.

The FATA scores 751, 752, 753 for Company A may be, for example, at a particular point in time: short-term score=25, medium-term score=55, and long-term score=80. Scores 751, 752, 753 may be displayed to a user with color coding of the scores or shading areas around the displayed scores. Red shading may, for example, indicate a sell recommendation and blue shading may, for example, indicate a buy recommendation. Various levels of shading may also be used to indicate the strength of a particular recommendation.

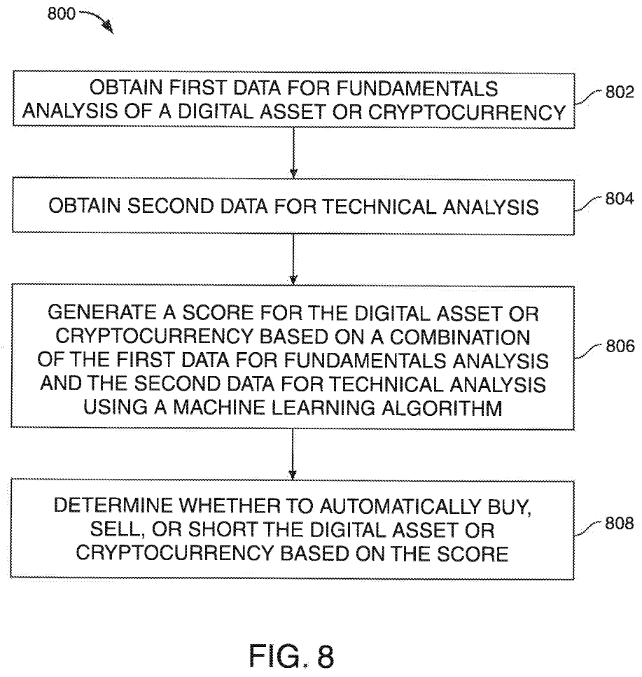

FIG. 8 shows a flow chart 800 that illustrates an example of steps that may be performed by the combined scoring application 740 for cryptocurrency B in accordance with principles of the disclosure. At step 802, first data may be obtained for performing a fundamentals analysis of cryptocurrency B. At step 804, second data may be obtained for performing a technical analysis of cryptocurrency B. The data that is obtained at steps 802 or 804 may include data inputs that are in condition for an analysis by the combined scoring application 740 or that may be determined before being obtained by combined scoring application 740. For example, a specific Bollinger band value may be provided to combined scoring application, or a graph of historical price data for cryptocurrency B may be provided to the combined scoring application 740 and combined scoring application 740 may determine the value required as an input based on the received graph data.

Next, at step 806, one or more scores may be generated in which each of the scores is based on a combination of the first data for fundamentals analysis and the second data for technical analysis for cryptocurrency B. Step 806 may include the use of a machine learning algorithm and AI, and behavioral analytics (BA) (which may account for system users' past actions) to determine the scores. At step 808, the score(s) may be output to an automated trading system that may leverage the scores to decide whether to automatically trade cryptocurrency B based on the scores.

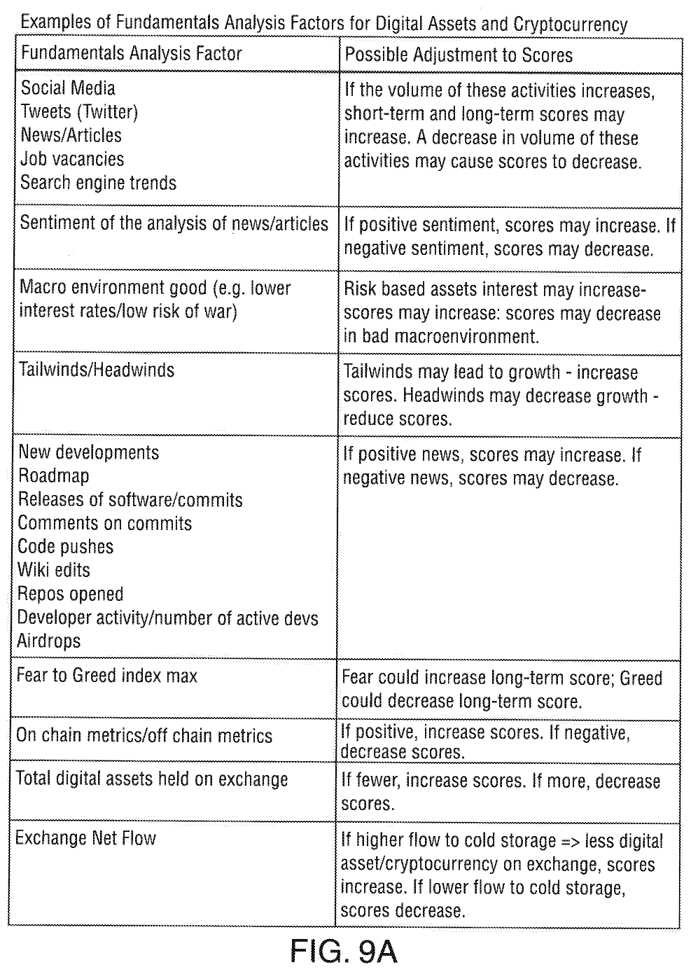

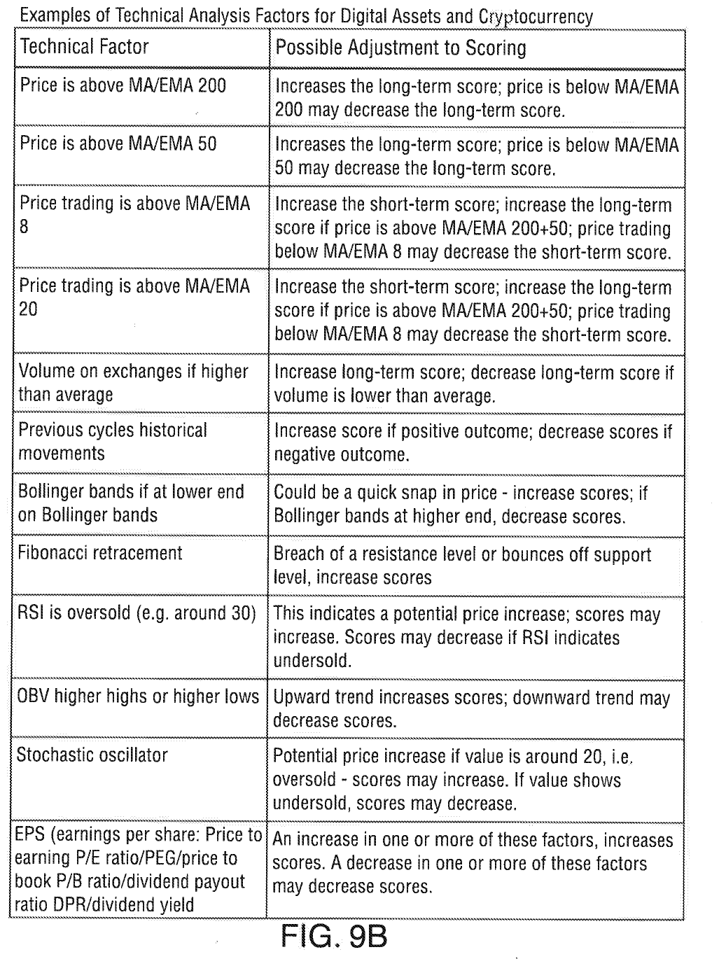

FIG. 9A shows examples of how some of the fundamentals data mentioned above may impact the scores for digital assets or cryptocurrency, where the highest scores in the range suggest a buy and the lowest scores suggest a sell. For example, if the volume of related social media activity (e.g., Twitter, Facebook, etc.), news, articles, or job vacancies increase, the short-term and long-term scores may increase. Similarly, scores may increase if the sentiment on the news and in articles is positive, the macroeconomic environment is good, interest rates go lower, the RSI or stochastic oscillator is in a range that indicates an oversold condition, OBV highs or lows go higher, there is a rise in earnings-per-share, increased dividend yield, on chain metrics or off chain metrics look positive, total digital assets held on exchange is reduced, or exchange net flow shows a higher flow to cold storage. If one or more of the fundamentals show a change in the opposite direction, one or more of the scores may decrease accordingly.

Each of the fundamentals data may be set to cause an incremental increase or decrease in score on a per-fundamental basis or some of the fundamentals may be analyzed as a group in a determination as to how the fundamentals may increase or decrease the score. Some fundamentals may be weighted more heavily, such as based on previous effectiveness of those fundamentals.

FIG. 9B shows examples of how some of the technical data mentioned above may generally impact the scores for digital assets or cryptocurrency. For example, where a stock price is above an MA or EMA 200, or an MA or EMA 80, the long-term score may increase. Where a stock an MA or EMA 8, or an MA or EMA 20, the short-term score may increase, and the long-term score may increase if the price is also above the MA or EMA 200 and MA or EMA 50. As another example, if the volume on the stock exchanges rises higher than average over a certain period “x”, the long-term score may increase. Scores may also increase, for example, where a current cycle resembles previous positive historical movements, if a Bollinger band is at a lower end, or a resistance level of a Fibonacci retracement is breached or there is a bounce off of a support level. If any technical data indicates show a change in the opposite direction, one or more of the scores may decrease. Each technical indicator may be set to cause an incremental increase or decrease in score on a per-indicator basis or some of the technical data may be analyzed as a group in a determination as to how the technical data may impact the score. For example, ranges of the RSI and stochastic oscillator may be considered together as a basis for determining an increase or decrease in scores. Some technical data may be weighted more heavily than other technical data.

As noted above, fundamentals analysis and technical analysis are both accounted for in generating the FATA scores. In embodiments, combined scoring application may base a first percentage of the scores upon various fundamentals and may base a second percentage on technical indicators. The percentages may be 50% each or the percentages may vary with more weight being given to either certain fundamentals or technical indicators.

One of ordinary skill in the art will appreciate that the steps shown and described herein may be performed in other than the recited order and that one or more steps illustrated may be optional. The methods of the above-referenced embodiments may involve the use of any suitable elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

Thus, a computer program product, methods, systems, and apparatus may use machine learning, artificial intelligence and/or behavioral analytics to provide one or more scores of a digital asset, cryptocurrency, or stock each based on data for one or more of each of fundamentals analysis and technical analysis. The score(s) may be used by an investor for strategic investment decisions or by an automated trading system to perform trades. Persons skilled in the art will appreciate that the present invention can be practiced by other than the described embodiments, which are presented for purposes of illustration rather than of limitation.

What is claimed is:

1. A combined fundamentals analysis and technical analysis scoring computer program product, the computer program product comprising executable instructions that, when executed by a processor on a computer system:
obtains first data for fundamentals analysis of a business by evaluating actual or perceived performance of the business, an industry in which the business is situated, or economic conditions associated with the business;
obtains second data for technical analysis to attempt to predict a value of a stock of the business based on historical market data for the stock;
generates a score based on a combination of the first data for fundamentals analysis and the second data for technical analysis of the stock, wherein a machine learning algorithm determines which of the first data for fundamentals analysis and the second data for technical analysis is selected to be used to generate the score, and wherein the score provides guidance for buying, selling, holding, or shorting the stock of the business; and
determines whether to automatically trade the stock for the user, using an automated trading system, based on the score.

2. The computer program product of claim 1, wherein the score represents one of a long-term score, a medium-term score, or a short-term score.

3. The computer program product of claim 2, wherein the executable instructions further:
generates one or more additional scores that represent one or more of the long-term score, the medium-term score, or the short-term score not represented by the score; and
leverages the one or more additional scores as additional guidance for determining whether to buy, sell, hold, or short the stock of the business.

4. The computer program product of claim 2, wherein long-term is more than a year in the future, medium-term is between six to twelve months in the future, and short-term is less than six months in the future.

5. The computer program product of claim 1, wherein the score is a numerical value within a range of values, and subranges within the range of values signify whether to buy, sell, hold, or short the stock.

6. The computer program product of claim 1, wherein the machine learning algorithm further determines weights to be applied to the selected first data for fundamentals analysis and the second data for technical analysis based on a relevance of each of the selected first data for fundamentals analysis and the second data for technical analysis as a predictor for the type of the score to be generated.

7. The computer program product of claim 6, where the executable instructions further obtain behavioral analytics data of investors that reflects past behavior of the investors, and wherein the generating of the score is further based on the behavioral analytics data.

8. The computer program product of claim 6, wherein the weighting of the first data for fundamentals analysis and the second data for technical analysis to generate the score is further based on an historical performance of each of the first data and the second data as a predictor for the type of the score to be generated.

9. The computer program product of claim 1, wherein the first data for fundamentals analysis comprises one or more of:
a report, an article, or a news item about the business, jobs or vacancies at the business, a social media posting, a tweet, a short-term scoring, a long-term scoring, a popularity of a search query, or a research rating for a buy, sell, hold, or overweight about the business, sentiment of analysis of the business in reports, news, or articles, a macroeconomic environment, or interest rates.

10. The computer program product of claim 1, wherein the second data for technical analysis comprises one or more of:
a moving average (MA) or an exponential moving average (EMA) of changes in the stock price over a predetermined duration, a volume on one or more stock exchanges in a time frame, a length of a period of analysis, historical movements of previous cycles, Bollinger bands, Fibonacci retracement, a relative strength index (RSI), on balance volume (OBV), a stochastic oscillator, total assets held on an exchange, earnings per share (EPS), a Price to Earnings (P/E) ratio, a Price to Earnings to Growth (P/E/G) ratio, a Price to Book (P/B) ratio, a Dividend Payout Ratio (DPR), a dividend yield, a ratio, or a yield.

11. A combined fundamentals analysis and technical analysis scoring computer program product, the computer program product comprising executable instructions that, when executed by a processor on a computer system:
obtains first data for fundamentals analysis that evaluates actual or perceived performance of a digital asset or cryptocurrency, the digital asset or cryptocurrency industry, or economic conditions associated with the digital asset or cryptocurrency;
obtains second data for technical analysis that attempts to predict a future value of the digital asset or cryptocurrency based on historical market data for the digital asset or cryptocurrency;
generates a score based on a combination of the first data for fundamentals analysis and the second data for technical analysis, wherein a machine learning algorithm determines which of the first data for fundamentals analysis and the second data for technical analysis is selected to be used to generate the score, wherein the score provides guidance for buying, selling, holding, or shorting the digital asset or cryptocurrency, and
determines whether to automatically buy, sell, or short the digital asset or cryptocurrency for the user based on the score.

12. The computer program product of claim 11, wherein the score represents one of a long-term score, a medium-term score, or a short-term score.

13. The computer program product of claim 12, wherein the executable instructions further:
generates one or more additional scores that represent one or more of the long-term score, the medium-term score, or the short-term score not represented by the score; and
leverages the one or more additional scores as additional guidance for determining whether to buy, sell, hold, or short the digital asset or cryptocurrency.

14. The computer program product of claim 12, wherein long-term is more than a year in the future, medium-term is between six to twelve months in the future, and short-term is less than six months in the future.

15. The computer program product of claim 11, wherein the score is a numerical value within a range of values, and subranges within the range of values signify whether to buy, sell, hold, or short the digital asset or cryptocurrency.

16. The computer program product of claim 11, wherein the machine learning algorithm further determines weights to be applied to the selected first data for fundamentals analysis and the second data for technical analysis based on a relevance of each of the selected first data for fundamentals analysis and the second data for technical analysis as a predictor for the type of the score to be generated.

17. The computer program product of claim 16, wherein the weighting of the first data for fundamentals analysis and the second data for technical analysis to generate the score is further based on an historical performance of each of the first data and the second data as a predictor for the type of the score to be generated.

18. The computer program product of claim 11, wherein the first data for fundamentals analysis comprises one or more of:
a report, an article, or a news item, a social media posting, a tweet, short-term scoring, long-term scoring, sentiment of analysis in reports, news, or articles about the digital asset or cryptocurrency, a macroeconomic environment, interest rates, total assets of the digital asset or cryptocurrency held on an exchange, new developments, a roadmap, releases of software, Github commits, code pushes, wiki edits, comments on commits, repurchase agreements (repos) opened, developer activity, number of active developers, airdrops, a Fear and Greed index, tokenomics of the digital asset or cryptocurrency including a monetary policy or a number of tokens of the digital asset in circulation, or a burning mechanism for the digital asset.

19. The computer program product of claim 11, wherein the second data for technical analysis comprises one or more of:
a moving average (MA) or an exponential moving average (EMA) of changes in the price of the digital asset or cryptocurrency over a predetermined duration, a volume on one or more exchanges in a time frame, a length of a period of analysis, historical movements of previous cycles, a research rating from another source for a buy, sell, hold, or overweight, Bollinger bands, Fibonacci retracement, an exchange net flow, a relative strength index (RSI), on balance volume (OBV), a stochastic oscillator, on chain metrics, off chain metrics, earnings per share (EPS), a Price to Earnings (P/E) ratio, a Price to Earnings to Growth (P/E/G) ratio, a Price to Book (P/B) ratio, a Dividend Payout Ratio (DPR), a dividend yield, a ratio, or a yield.

20. A non-transitory computer-readable memory storing computer-executable instructions that, when executed by a processor on a computer, cause the computer to:
obtains first data for fundamentals analysis of a business that evaluate actual or perceived performance of the business, an industry in which the business is situated, or economic conditions associated with the business;
obtains second data for technical analysis to attempt to predict a value of a stock of the business based on historical market data for the stock;
generates a score based on a combination of the first data for fundamentals analysis and the second data for technical analysis of the stock, wherein a machine learning algorithm determines which of the first data for fundamentals analysis and the second data for technical analysis is selected to be used to generate the score and determines weights to be applied to each of the selected first data for fundamentals analysis and the second data for technical analysis to generate the score; and wherein the score provides guidance for buying, selling, holding, or shorting the stock of the business, and
automatically trades, using an automated trading system, the stock for the user based on the score.

21. A non-transitory computer-readable memory storing computer-executable instructions that, when executed by a processor on a computer, cause the computer to:
obtains first data for fundamentals analysis that evaluates actual or perceived performance of a digital asset or cryptocurrency, the digital asset or cryptocurrency industry, or economic conditions associated with the digital asset or cryptocurrency;
obtains second data for technical analysis that attempts to predict a future value of the digital asset or cryptocurrency based on historical market data for the digital asset or cryptocurrency;
generates a score based on a combination of the first data for fundamentals analysis and the second data for technical analysis, wherein a machine learning algorithm determines which of the first data for fundamentals analysis and the second data for technical analysis is selected to be used to generate the score and determines weights to be applied to the selected first data for fundamentals analysis and the second data for technical analysis to generate the score; and wherein the score provides guidance for buying, selling, holding, or shorting the digital asset or cryptocurrency, and
automatically trades, using an automated trading system, the digital asset or cryptocurrency for the user based on the score.
